(19) United States
(12) Patent Application Publication
(10) Pub. No.: US 2015/0180336 A1
(43) Pub. Date: Jun. 25, 2015

(54) APPARATUS AND METHOD FOR TRACKING MAXIMUM POWER

(71) Applicant: Electronics and Telecommunications Research Institute, Daejeon (KR)

(72) Inventors: Sewan HEO, Daejeon (KR); Yil Suk YANG, Daejeon (KR)

(73) Assignee: Electronics and Telecommunications Research Institute, Daejeon (KR)

(21) Appl. No.: 14/290,270

(22) Filed: May 29, 2014

(30) Foreign Application Priority Data
Dec. 23, 2013 (KR) 10-2013-0161666

(51) Int. Cl. H02M 3/158; H02M 1/08

(52) U.S. Cl. CPC H02M 3/158; H02M 1/08

(57) ABSTRACT

Provided is a maximum power tracking apparatus. The apparatus includes a battery outputting first power, a switching unit, in response to a switching control signal, converting the first power into second power, and a pulse signal generation unit, based on the first power, controlling a pulse width of the switching control signal and controlling a frequency of the switching control signal.

### CROSS-REFERENCE TO RELATED APPLICATIONS

This U.S. non-provisional patent application claims priority under 35 U.S.C. §119 of Korean Patent Application No. 10-2013-0161666, filed on Dec. 23, 2013, the entire contents of which are hereby incorporated by reference.

### BACKGROUND OF THE INVENTION

The present invention disclosed herein relates to a maximum power tracking apparatus, and more particularly, to an apparatus and a method for tracking maximum power, maximizing conversion efficiency of a direct current (DC)-DC converter.

Recently, new renewable energies have been variously developed. Among new renewable energies, particularly, solar batteries collecting solar energies and converting solar energies into electric energies have been variously developed.

Energy amounts of solar batteries differ according to the strength of sunlight or an angle of light. Particularly, it is impossible to artificially change the strength of sunlight, which is an external environmental factor. Also, although the angle of sunlight is controllable by changing a direction of solar cells, a large amount of power is consumed while changing the direction.

Also, it is easy to control output power outputted from solar cells based on an output voltage. That is, a level of the output voltage is controlled, thereby extracting maximum power from solar cells.

### SUMMARY OF THE INVENTION

The present invention provides an apparatus and a method for tracking maximum power, capable of reducing a loss occurring while converting power outputted from a solar battery into power corresponding to a load.

Embodiments of the present invention provide maximum power tracking apparatuses including a battery outputting first power, a switching unit, in response to a switching control signal, converting the first power into second power, and a pulse signal generation unit, based on the first power, controlling a pulse width of the switching control signal and controlling a frequency of the switching control signal.

In some embodiments, the apparatus may further include a pulse control unit generating a pulse control signal for controlling the pulse width of the switching control signal. Herein, the pulse control unit, when a level of an output voltage according to the first power increases, may generate the pulse control signal for reducing the pulse width of the switching control signal.

In other embodiments, the pulse control unit, when the level of the output voltage according to the first power decreases, may generate the pulse control signal for increasing the pulse width of the switching control signal.

In still other embodiments, the pulse control unit may include a memory storing the pulse width corresponding to the output voltage, allowing power conversion efficiency of the switching unit to be increased. Herein, the pulse width of the switching control signal may be controlled by referring to the memory for the stored pulse width.

In even other embodiments, the apparatus may further include a voltage control unit generating a frequency control signal for controlling the frequency of switching control signal. Herein, the voltage control unit may receive the pulse control signal for controlling the pulse width and the first power and may generate the frequency control signal in response to the output voltage of the first power.

In yet other embodiments, the voltage control unit, when a level of the output voltage of the first power increases, may generate the frequency control signal to allow the frequency to increase.

In further embodiments, the voltage control unit, when a level of the output voltage of the first power decreases, may generate the frequency control signal to allow the frequency to decrease.

In still further embodiments, the pulse signal generation unit, in response to the pulse control signal and the frequency control signal, may generate the switching control signal. Herein, the switching unit, in response to the switching control signal, may convert the first power into the second power.

In even further embodiments, the battery may receive solar energy and may convert the solar energy into electric energy.

In yet further embodiments, the voltage control unit may employ maximum power point tracking (MPPT).

In other embodiments of the present invention, methods of tracking maximum power include receiving first power from a solar battery, controlling a pulse width of a switching control signal according to an output voltage of the first power in response to an output voltage stored in a memory, controlling a frequency of the switching control signal in response to the output voltage of the first power, and converting the first power into second power in response to the switching control signal.

In some embodiments, the method may further include, when the output voltage of the first power is higher than the output voltage stored in the memory, reducing the pulse width of the switching control signal referring to the memory for the switching control signal corresponding to the output voltage stored therein.

In other embodiments, the method may further include, when the output voltage of the first power is higher than the output voltage stored in the memory, increasing the pulse width of the switching control signal referring to the memory for the switching control signal corresponding to the output voltage stored therein.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a block diagram of a maximum power tracking apparatus according to an embodiment of the present invention;

FIG. 2 is a graph illustrating a point on which power outputted from a solar battery has a maximum value according to current-voltage properties;

FIG. 3 is a graph illustrating a level of a current applied to an inductor according to a level of each power shown in FIG. 2;

FIG. 4 illustrates graphs illustrating operations of a pulse control unit when an output voltage of first power shown in FIG. 2 increases;

FIG. 5 illustrates graphs illustrating operations of the pulse control unit when the output voltage of the first power shown in FIG. 2 decreases;

FIG. 6 illustrates operating properties of a voltage control unit shown in FIG. 1; and

FIG. 7 is a flowchart illustrating a method of operating the maximum power tracking apparatus according to another embodiment of the present invention.

### DETAILED DESCRIPTION OF PREFERRED EMBODIMENTS

Since embodiments of the present invention may have various modifications and several shapes, exemplary embodiments will be shown in the drawings and will be described in detail. However, the inventive concept is not limited to the exemplary embodiments but should be understood as including all modifications, equivalents, and substitutes included in the spirits and scope of the inventive concept.

Throughout the respective drawings, like reference numerals designate like elements. In the attached drawings, sizes of structures are more enlarged than they actually are for clarity of the inventive concept. Terms such as “first” and “second” may be used to describe various elements, but the elements are not limited to the terms. The terms are used merely to distinguish one element from another. For example, within the scope of the present invention, a first component may be designated as a second component, and similarly, the second component may be designated as the first component. Singular expressions, unless defined otherwise in contexts, include plural expressions.

In the present specification, terms of “comprise” or “have” are used to designate features, numbers, steps, operations, elements, components or combinations thereof disclosed in the specification as being present but not to exclude possibility of the existence or the addition of one or more other features, numbers, steps, operations, elements, components, or combinations thereof.

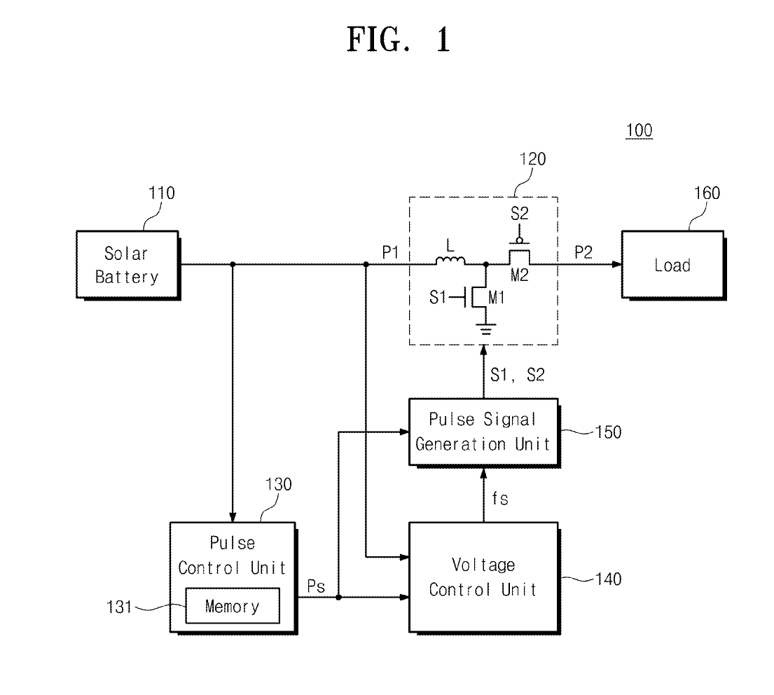

FIG. 1 is a block diagram of a maximum power tracking apparatus 100 according to an embodiment of the present invention. Referring to FIG. 1, the maximum power tracking apparatus 100 includes a solar battery 110, a switching unit 120, a pulse control unit 130, a voltage control unit 140, a pulse signal generation unit 150, and a load 160.

In the embodiment, the maximum power tracking apparatus 100 may operate based on pulse frequency modulation.

In detail, the solar battery 110 receives solar energy from the sun and converts the solar energy into electric energy. That is, the solar battery 110 converts the received solar energy into first power P1 having a form of electric energy. The solar battery 110 transfers the converted first power P1 to the switching unit 120, the pulse control unit 130, and the voltage control unit 140, respectively. Herein, the first power P1 may be determined by multiplying an output voltage by an output current. Also, throughout the description, the output voltage may be a voltage outputted from the first power P1.

Generally, the strength of solar energy is not artificially changeable. Merely, the strength of the solar energy may be controlled by adjusting an angle of sunlight, which consumes a large amount of power. Accordingly, a level of output power is controlled by adjusting an output current based on an output voltage of the solar battery 110.

The switching unit 120 receives power outputted from the solar battery, that is, the first power P1 and converts the first power P1 into second power P2 corresponding to driving of the load 160. For example, the switching unit 120 may convert power through direct current (DC)-DC conversion.

In detail, the switching unit 120 includes an N-channel metal oxide semiconductor (NMOS) transistor M1, a P-channel metal oxide semiconductor (PMOS) transistor M2, and an inductor L.

The NMOS and PMOS transistors M1 and M2 may be controlled by first and second switching control signals S1 and S2 outputted from the pulse signal generation unit 150. In detail, when the NMOS transistor M1 is turned on in response to the first switching control signal S1, the PMOS transistor M2 is turned off by the second switching control signal S2. Herein, the inductor L is charged with a current.

Also, when the NMOS transistor M1 is turned off in response to the first switching control signal S1, the PMOS transistor M2 is turned on by the second switching control signal S2. Herein, the current in the inductor L is transferred to the load 160.

That is, the NMOS and PMOS transistors M1 and M2 may be operated complementarily to each other. Also, the switching unit 120 has been described as being configured to be a DC-DC boost but is not limited thereto and may be variously configured to be a buck or a buck boost.

As described above, the switching unit 120 may convert a level of the first power P1 into a level of the second power P2 in response to the first and second switching control signals S1 and S2. The switching unit 120 may output maximum power through the first and second switching control signals S1 and S2 controlling the level of the output voltage.

However, a loss of power may occur while the switching unit 120 is converting the first power P1 into the second power P2 and the loss of power may vary with a level of the current provided to the inductor L. For example, as the level of the first power P1 outputted from the solar battery 110 varies depending on environmental factors, the level of the current applied to the inductor L may vary. For example, as the level of the output voltage outputted from the solar battery 110 increases, the level of the current applied to the inductor L increases. On the contrary, generally, as the level of the output voltage outputted from the solar battery 110 decreases, the level of the current applied to the inductor L decreases.

Generally, the switching unit 120 is designed to allow the level of the current applied to the inductor L to have maximum conversion efficiency at a certain current level. However, as the level of the first power P1 varies, the level of the output voltage varies, thereby allowing the level of the current applied to the inductor L of the switching unit 120 to vary. Due thereto, as the level of the current applied to the inductor L differs from the certain current level, power conversion efficiency may decrease.

That is, the power conversion efficiency of the switching unit 120 may be maximized when the level of the current applied to the inductor L has the certain current level corresponding to the output voltage.

For this, the maximum power tracking apparatus 100 may reduce the loss of power occurring in the switching unit 120 by controlling the level of the current applied to the inductor L. As described above, as the level of the current applied to the inductor L is controlled, the power conversion efficiency of the switching unit may increase. The pulse control unit 130 receives the first power P1 from the solar battery 110. The pulse control unit 130, based on the level of the output voltage according to the first power P1, determines a pulse width of the first and second switching control signals S1 and S2 to be outputted from the pulse signal generation unit 150. Also, the pulse control unit 130, based on the output voltage, may generate a pulse control signal Ps determining the pulse width of the first and second switching control signals S1 and S2.

For example, when the level of the output voltage increases, the pulse control unit 130 may generate the pulse control signal Ps to allow the pulse width of the first and second switching control signals S1 and S2 to become smaller. On the contrary, when the level of the output voltage decreases, the pulse control unit 130 may generate the pulse control signal Ps to allow the pulse width of the first and second switching control signals S1 and S2 to become greater.

Also, in the embodiment, the pulse control unit 130 may include a memory 131. The memory 131 may store optimum pulse widths corresponding to respective output voltages. Accordingly, the pulse control unit 130 may generate the pulse control signal Ps corresponding to the output voltage received from the solar battery 110 referring to the optimum pulse widths corresponding to the respective output voltages stored in the memory 131.

The pulse control unit 130 generates the pulse control signal Ps as described above and provides the voltage control unit 140 and the pulse signal generation unit 150 with the pulse control signal Ps.

The voltage control unit 140 receives the first power P1 from the solar battery 110 and receives the pulse control signal Ps from the pulse control unit 130. The voltage control unit 140 determines a frequency of the first and second switching control signals S1 and S2 to be generated from the pulse signal generation unit 150, based on the level of the output voltage of the first power P1.

In detail, the voltage control unit 140, based on the output voltage, determines the frequency of the first and second switching control signals according to the pulse control signal Ps. The voltage control unit 140 generates a frequency control signal fs for determining the frequency of the first and second switching control signals S1 and S2 and provides the pulse signal generation unit 150 with the generated frequency control signal fs. Also, when the frequency control signal fs is generated from the voltage control unit 140, the pulse width of the first and second switching control signals S1 and S2 determined by the pulse control unit 130 are uniformly maintained. That is, the pulse width of the first and second switching control signals S1 and S2 in a high level section are not changed.

For example, the voltage control unit 140, when the level of the output voltage increases, may control the frequency of the first and second switching control signals S1 and S2 to increase. In this case, the pulse width of the first and second switching control signals S1 and S2 are not changed in the high level section but may be reduced in a low section thereof. That is, as the level of the output current increases, the level of the output voltage may decrease.

On the contrary, the voltage control unit 140, when the level of the output voltage decreases, may control the frequency to decrease. In this case, the pulse width of the first and second switching control signals S1 and S2 are not changed in the high level section but may increase in a low section thereof. That is, as the level of the output current decreases, the level of the output voltage may increase.

Also, in the embodiment, the voltage control unit 140 may employ maximum power point tracking (MPPT).

The pulse signal generation unit 150 receives the pulse control signal Ps from the pulse control unit 130 and receives the frequency control signal fs from the voltage control unit 140. The pulse signal generation unit 150, in response to the pulse control signal Ps and the frequency control signal fs, generates the first and second switching control signals S1 and S2. In response to the first and second switching control signals S1 and S2, the NMOS and PMOS transistors M1 and M2 may operate.

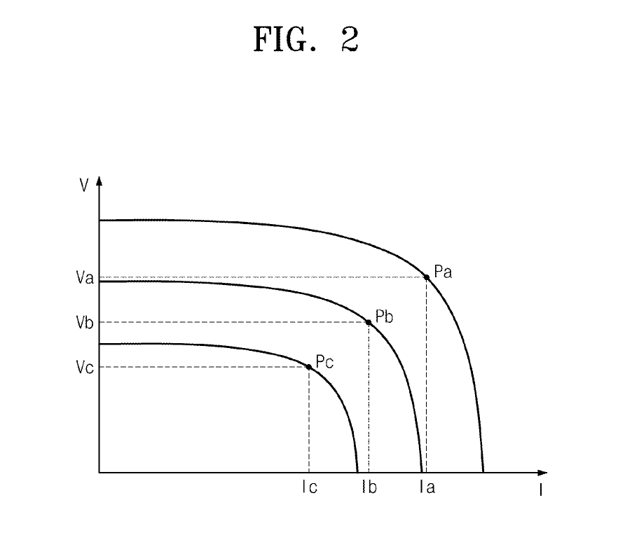

FIG. 2 is a graph illustrating a point on which power outputted from the solar battery 110 has a maximum value according to current-voltage properties. An x-axis indicates a level of an output current, and a y-axis indicates a level of an output voltage.

Generally, due to external environmental factors, a level of the power outputted from the solar battery 110 may vary. For example, according to first to third strengths of sunlight, first to third powers Pa, Pb, and Pc shown in FIG. 2 may be outputted respectively. In detail, the first power Pa is outputted according to the first strength of sunlight, the second power Pb is outputted according to the second strength, and the third power Pc is outputted according to the third strength. Herein, the respective strength of sunlight may be fixed.

As an example, the first power Pa outputted from the solar battery 110 in response to the first strength of sunlight may have maximum power based on a first output voltage Va and a first output current Ia. Herein, the first output voltage Va and the first output current Ia may be a voltage and a current for allowing a level of the first power Pa to be the maximum power.

As an example, the second power Pb outputted from the solar battery 110 in response to the second strength of sunlight may have maximum power based on a second output voltage Vb and a second output current Ib. Herein, the second output voltage Vb and the second output current Ib may be a voltage and a current for allowing a level of the second power Pb to be the maximum power.

As an example, the third power Pc outputted from the solar battery 110 in response to the third strength of sunlight may have maximum power based on a third output voltage Vc and a third output current Ic. Herein, the third output voltage Vc and the third output current Ic may be a voltage and a current for allowing a level of the third power Pc to be the maximum power.

Generally, as the level of the power outputted from the solar battery 110 increases, a larger amount of power may be provided to the load 160. Also, as the level of the power outputted from the solar battery 110 increases, a level of a corresponding output voltage increases. Also, corresponding to the output voltage, a level of a current applied to the inductor L increases.

Accordingly, as the level of the first power Pa is higher than the level of the second power Pb, a level of the first output voltage Va is higher than a level of the second output voltage Vb. As the level of the second power Pb is higher than the level of the third power Pc, the level of the second voltage Vb is higher than a level of the third output voltage Vc.

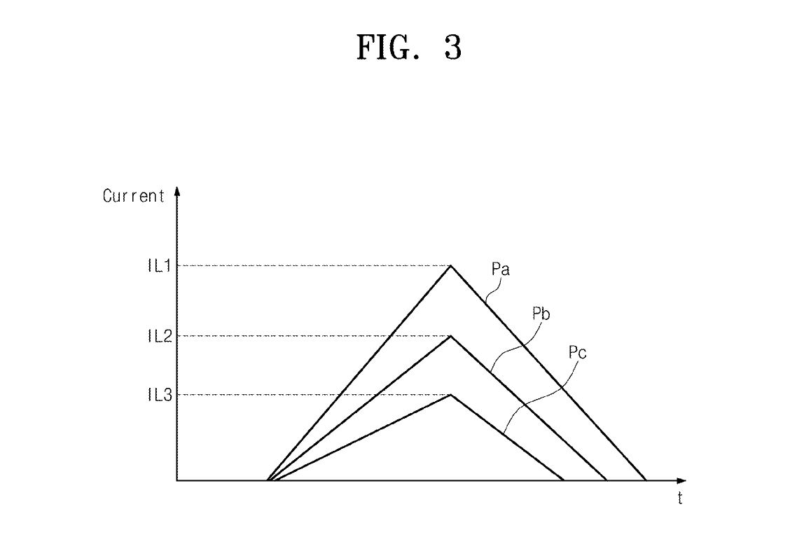

FIG. 3 is a graph illustrating a level of a current applied to the inductor L according to the levels of the respective powers shown in FIG. 2. An x-axis indicates time, and a y-axis indicates the level of the current applied to the inductor L.

Referring to FIG. 3, there are shown levels of currents applied to the inductor L according to the first to third powers Pa, Pb, and Pc shown in FIG. 2.

A level of a first current IL1 based on the first power Pa is higher than a level of a second current IL2 based on the second power Pb. Herein, the first output voltage Va of the first power Pa is higher than the second output voltage Vb of the second power Pb. Also, the level of the second current IL2 based on the second power Pb is higher than a level of a third current IL3 based on the third power Pc. Herein, the second output voltage Vb of the second power Pb is higher than the third output voltage Vc of the third power Pc.

As described above, as the output voltage according to the respective powers increases, the level of the current applied to the inductor L may increase. That is, as the level of the output voltage varies, the level of the current applied to the inductor L may vary.

However, the switching unit 120 may have maximum conversion efficiency when the current applied to the inductor L has a certain current level. Due thereto, when the level of the current applied to the inductor L varies, conversion efficiency of the switching unit 120 may decrease. Accordingly, the maximum power tracking apparatus 100 sets the current applied to the inductor L to maintain the certain current level corresponding to the output voltage.

Also, generally, an output current of the solar battery 110 is uniformly maintained through frequency controlling of the voltage control unit 140. That is, since a change in the level of the current applied to the inductor L does not have an effect on the mean of the output current, the change may be considered as having no effect on a value of the power outputted from the solar battery 110. Merely, the level of the current applied to the inductor L is set to have maximum conversion efficiency while the switching unit 120 is converting the first power P1 into the second power P2.

For example, the maximum power tracking apparatus 100, when the output voltage increases, may reduce the level of the current applied to the inductor L by controlling a pulse width. On the contrary, the maximum power tracking apparatus 100, when the output voltage decreases, may increase the level of the current applied to the inductor L by controlling the pulse width. That is, the maximum power tracking apparatus 100 controls the level of the current applied to the inductor L to allow the power conversion efficiency of the switching unit 120 to be maximized.

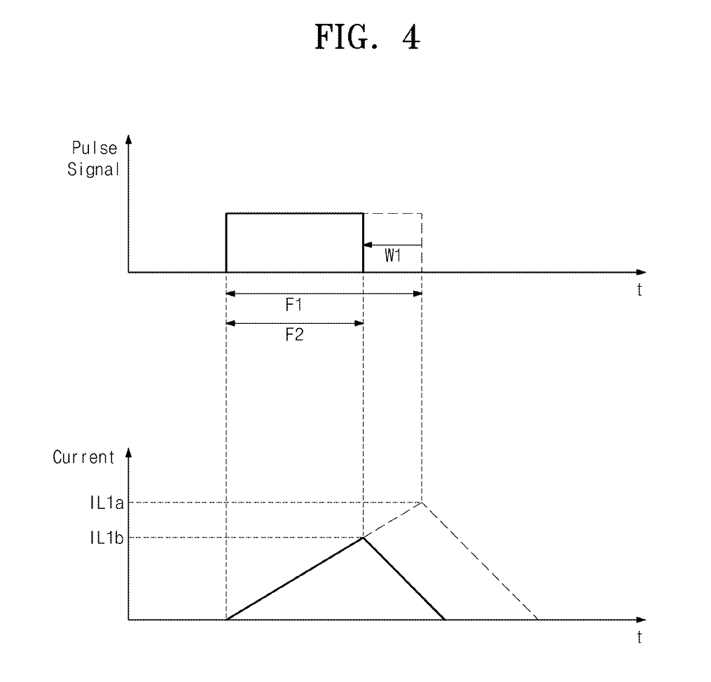

FIG. 4 illustrates graphs illustrating operations of the pulse control unit 130 when the output voltage of the first power P1 shown in FIG. 2 increases.

Referring to FIGS. 1 to 4, in the graph illustrating a pulse signal, an x-axis indicates time and a y-axis indicates a level of the first and second switching control signals S1 and S2. Also, in the graph illustrating a current level, an x-axis indicates time t and a y-axis indicates a level of a current applied to the inductor L according to a pulse width of the first and second switching control signals S1 and S2.

Typically, to generate maximum power from the solar battery 110, the pulse control unit 130 sets the first and second switching control signals S1 and S2 to have a first pulse width F1 based on the output voltage. As a result thereof, according to the first pulse width F1 of the first and second switching control signals S1 and S2, a level of a first current IL1a is applied to the inductor L.

However, to allow the switching unit 120 to have maximum conversion efficiency, it is necessary to apply a second current IL1b to the inductor L. Herein, the second current IL1b may be a certain current for allowing the switching unit 120 to have the maximum conversion efficiency. The second current IL1b may be provided to the inductor L according to a second pulse width F2 of the first and second switching control signals S1 and S2 generated corresponding to the first output voltage Va.

That is, when the first and second switching control signals S1 and S2 corresponding to the first output voltage Va have the second pulse width F2, a level of the second current IL1b may be applied to the inductor L. As a result thereof, the switching unit 120 may operate with the maximum conversion efficiency.

The pulse control unit 130, to control the level of the current applied to the inductor L, may control the pulse width of the first and second switching control signals S1 and S2. In detail, when the pulse control unit 130 receives an output voltage higher than the first output voltage Va from the solar battery 110, the level of the current applied to the inductor L may increase. Accordingly, to allow the switching unit 120 to have the maximum conversion efficiency, a current level referring to the second pulse width F2 corresponding to the first output voltage Va may be applied to the inductor L. Herein, the second pulse width F2 based on the first output voltage Va may be obtained by referring to the memory 131.

For example, when receiving the output voltage higher than the first output voltage Va, the pulse control unit 130 refers to the memory 131 for the second pulse width F2 corresponding to the first output voltage Va. The pulse control unit 130 generates the pulse control signal Ps based on the second pulse width F2. That is, as shown in FIG. 4, to decrease the level of the current applied to the inductor L, the pulse control unit 130 reduces the first pulse width F1 of the first and second switching control signals S1 and S2 to the second pulse width F2 by a time of W1.

Accordingly, in response to the second pulse width F2 of the first and second switching control signals S1 and S2, the level of the current applied to the inductor L may decrease from the first current IL1a to the second current IL1b.

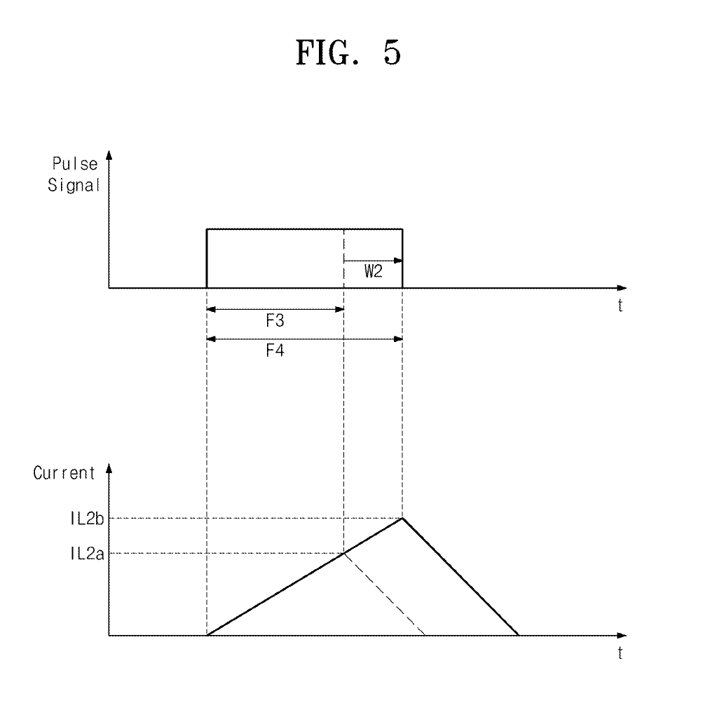

FIG. 5 illustrates graphs illustrating operations of the pulse control unit 130 when the output voltage of the first power P1 shown in FIG. 2 decreases.

Referring to FIG. 5, in the graph illustrating a pulse signal, an x-axis indicates time and a y-axis indicates a level of the first and second switching control signals S1 and S2. Also, in the graph illustrating a current level, an x-axis indicates time t and a y-axis indicates a level of a current applied to the inductor L according to a pulse width of the first and second switching control signals S1 and S2.

Typically, to generate maximum power from the solar battery 110, the pulse control unit 130 sets the first and second switching control signals S1 and S2 to have a third pulse width F3 based on the output voltage. As a result thereof, according to the third pulse width F3 of the first and second switching control signals S1 and S2, a level of a first current IL2a is applied to the inductor L.

However, to allow the switching unit 120 to have maximum conversion efficiency, it is necessary to apply a second current IL2b to the inductor L. Herein, the second current IL2b may be a certain current for allowing the switching unit 120 to have the maximum conversion efficiency. The second current IL2b may be provided to the inductor L according to a fourth pulse width F4 of the first and second switching control signals S1 and S2 generated corresponding to the first output voltage Va.

That is, when the first and second switching control signals S1 and S2 corresponding to the first output voltage Va have the fourth pulse width F4, a level of the second current IL2b may be applied to the inductor L. As a result thereof, the switching unit 120 may operate with the maximum conversion efficiency.

The pulse control unit 130, to control the level of the current applied to the inductor L, may control the pulse width of the first and second switching control signals S1 and S2. In detail, when the pulse control unit 130 receives an output voltage lower than the first output voltage Va from the solar battery 110, the level of the current applied to the inductor L may decrease. Accordingly, to allow the switching unit 120 to have the maximum conversion efficiency, a current level referring to the fourth pulse width F4 corresponding to the first output voltage Va may be applied to the inductor L. Herein, the fourth pulse width F4 based on the first output voltage Va may be obtained by referring to the memory 131.

For example, when receiving the output voltage lower than the first output voltage Va, the pulse control unit 130 refers to the memory 131 for the fourth pulse width F4 corresponding to the first output voltage Va. The pulse control unit 130 generates the pulse control signal Ps based on the fourth pulse width F4. That is, as shown in FIG. 5, to increase the level of the current applied to the inductor L, the pulse control unit 130 increases the third pulse width F3 of the first and second switching control signals S1 and S2 to the fourth pulse width F4 by a time W2.

Accordingly, in response to the fourth pulse width F4 of the first and second switching control signals S1 and S2, the level of the current applied to the inductor L may increase from the first current IL2a to the second current IL2b.

As described with reference to FIGS. 4 and 5, the pulse control unit 130 may generate the pulse control signal Ps by referring to the optimum pulse width corresponding to the output voltage.

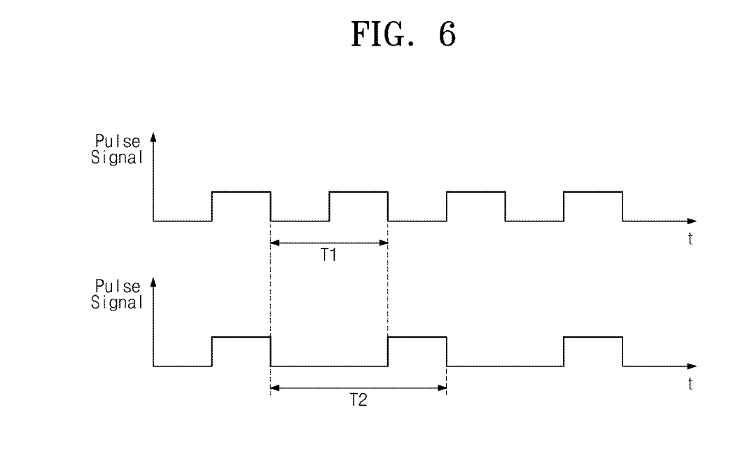

FIG. 6 illustrates operating properties of the voltage control unit 140. An x-axis indicates time, and a y-axis indicates a signal level of the first and second switching control signals S1 and S2.

Referring to FIGS. 1 and 6, in the embodiment, the maximum power tracking apparatus 100, based on an output voltage outputted from the solar battery 110, may control a frequency of the first and second switching signals S1 and S2. In detail, the voltage control unit 140, when a level of the output voltage is set to be high, may set a frequency corresponding to the first and second switching control signals S1 and S2 to be high. Accordingly, in response to the first and second switching control signals S1 and S2, a level of an output current may increase, and according thereto, the level of the output voltage may decrease.

On the contrary, the voltage control unit 140, when the level of the output voltage is set to be low, may set the frequency corresponding to the first and second switching control signals S1 and S2 to be low. Accordingly, in response to the first and second switching control signals S1 and S2, the level of the output current may decrease, and according thereto, the level of the output voltage may increase.

In detail, a pulse signal having a first period T1 corresponds to a case, in which the level of the output voltage outputted from the solar battery 110 increases, and a pulse signal having a second period T2 corresponds to a case, in which the level of the output voltage outputted from the solar battery 110 decreases. Herein, the pulse signal may be the first and second switching control signals S1 and S2. Also, a pulse width of the first period T1 and a pulse width of the second period T2 are shown to be identical but not limited thereto. That is, the pulse width of the first period T1 and the pulse width of the second period T2 may be different from each other.

As shown in FIG. 6, the first period T1 may be shorter than the second period T2. That is, the voltage control unit 140, when the level of the output voltage increases, generates the frequency control signal fs corresponding to the first period T1 referring to the pulse control signal Ps according to the output voltage. Also, the voltage control unit 140, when the level of the output voltage decreases, generates the frequency control signal fs corresponding to the second period T2 referring to the pulse control signal Ps according to the output voltage.

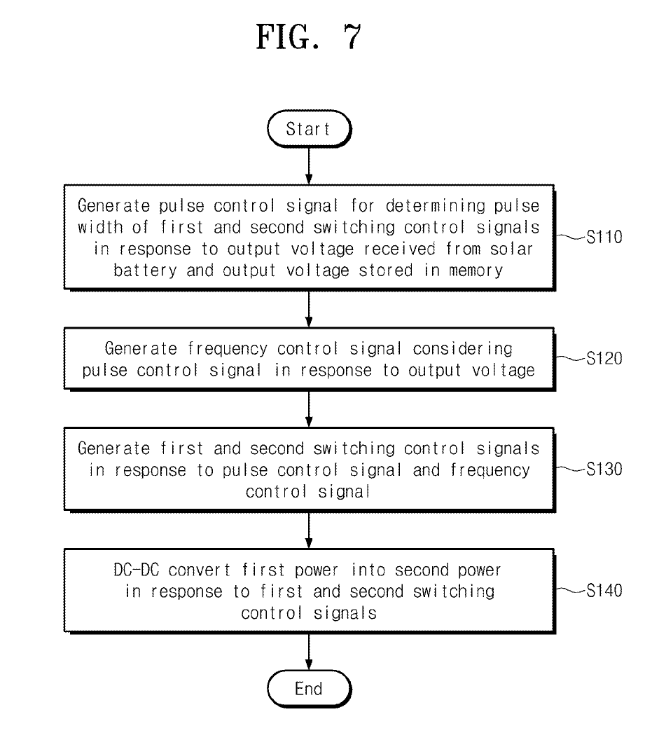

FIG. 7 is a flowchart illustrating a method of operating the maximum power tracking apparatus 100 according to another embodiment of the present invention.

Referring to FIGS. 1 to 7, in operation S110, the pulse control unit 130, in response to the output voltage outputted from the solar battery 110, generates the pulse control signal Ps for determining the pulse width of the first and second switching control signals S1 and S2. Herein, the pulse control unit 130 refers to the memory 131 for the pulse width of the output voltage to allow the power conversion efficiency of the switching unit 120.

In operation S120, the voltage control unit 140, in response to the output voltage, generates the frequency control signal fs based on the pulse control signal Ps.

In operation S130, the pulse signal generation unit 150, in response to the pulse control signal Ps and the frequency control signal fs, generates the first and second switching control signals S1 and S2.

In operation S140, the switching unit 120, in response to the first and second switching control signals S1 and S2, DC-DC converts the first power P1 outputted from the solar battery 110 into the second power P2.

As described above, the maximum power tracking apparatus 100, based on the level of the output voltage, may control the level of the current applied to the inductor L by controlling the frequency and the pulse width based on the level of the output voltage. That is, the level of the current applied to the inductor L is controlled, thereby minimizing a loss in conversion efficiency while the switching unit 120 is converting the power. Accordingly, overall driving performance of the maximum power tracking apparatus 100 may be improved.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A maximum power tracking apparatus comprising:
a battery outputting first power;
a switching unit, in response to a switching control signal, converting the first power into second power; and
a pulse signal generation unit, based on the first power, controlling a pulse width of the switching control signal and controlling a frequency of the switching control signal.

2. The apparatus of claim 1, further comprising a pulse control unit generating a pulse control signal for controlling the pulse width of the switching control signal,
wherein the pulse control unit, when a level of an output voltage according to the first power increases, generates the pulse control signal for reducing the pulse width of the switching control signal.

3. The apparatus of claim 2, wherein the pulse control unit, when the level of the output voltage according to the first power decreases, generates the pulse control signal for increasing the pulse width of the switching control signal.

4. The apparatus of claim 2, wherein the pulse control unit comprises a memory storing the pulse width corresponding to the output voltage, allowing power conversion efficiency of the switching unit to be increased,
wherein the pulse width of the switching control signal is controlled by referring to the memory for the stored pulse width.

5. The apparatus of claim 2, further comprising a voltage control unit generating a frequency control signal for controlling the frequency of switching control signal,
wherein the voltage control unit receives the pulse control signal for controlling the pulse width and the first power and generates the frequency control signal in response to the output voltage of the first power.

6. The apparatus of claim 5, wherein the voltage control unit, when a level of the output voltage of the first power increases, generates the frequency control signal to allow the frequency to increase.

7. The apparatus of claim 5, wherein the voltage control unit, when a level of the output voltage of the first power decreases, generates the frequency control signal to allow the frequency to decrease.

8. The apparatus of claim 5, wherein the pulse signal generation unit, in response to the pulse control signal and the frequency control signal, generates the switching control signal,
wherein the switching unit, in response to the switching control signal, converts the first power into the second power.

9. The apparatus of claim 1, wherein the battery receives solar energy and converts the solar energy into electric energy.

10. The apparatus of claim 1, wherein the voltage control unit employs maximum power point tracking (MPPT).

11. A method of tracking maximum power, comprising:
receiving first power from a solar battery;
controlling a pulse width of a switching control signal according to an output voltage of the first power in response to an output voltage stored in a memory;
controlling a frequency of the switching control signal in response to the output voltage of the first power; and
converting the first power into second power in response to the switching control signal.

12. The method of claim 11, further comprising, when the output voltage of the first power is higher than the output voltage stored in the memory, reducing the pulse width of the switching control signal referring to the memory for the switching control signal corresponding to the output voltage stored therein.

13. The method of claim 11, further comprising, when the output voltage of the first power is lower than the output voltage stored in the memory, increasing the pulse width of the switching control signal referring to the memory for the switching control signal corresponding to the output voltage stored therein.
